(19) United States
(12) Patent Application Publication
(10) Pub. No.: US 2026/0148041 A1
(43) Pub. Date: May 28, 2026

(54) SYSTEMS AND METHODS FOR AUTOMATICALLY CORRELATING DATA OF UNSTRUCTURED DATASETS FROM DISPARATE DISCLOSURE SOURCES

(71) Applicant: BANK OF AMERICA CORPORATION, Charlotte, NC (US)

(72) Inventors: Anbarasan Murthy, Chennai (IN); Sameer Dutta, Gurugram (IN); Dheeraj Srivastava, Uttar Pradesh (IN); Mudit Chawla, Gurugram (IN); Iruvanti John Dinakar, Telangana (IN)

(73) Assignee: BANK OF AMERICA CORPORATION, Charlotte, NC (US)

(21) Appl. No.: 18/962,609

(22) Filed: Nov. 27, 2024

(51) Int. Cl. G06N 3/045; G06F 16/38

(52) U.S. Cl. CPC G06N 3/045; G06F 16/38; G06F 2216/11

(57) ABSTRACT

Systems, computer program products, and methods are described herein for automatically correlating data of unstructured datasets from disparate disclosure sources. The present disclosure is configured to identify application metadata associated with at least one application; access at least one database comprising a plurality of unstructured datasets; input the application metadata and the plurality of unstructured datasets to a graph synthesizer; generate, by the graph synthesizer, a correlation score between the application metadata and the plurality of unstructured datasets; and determine, based on the correlation score, the at least one application is highly correlated to at least one unstructured dataset of the plurality of unstructured datasets or is low correlated to the plurality of unstructured datasets.

### TECHNOLOGICAL FIELD

Example embodiments of the present disclosure relate to automatically correlating data of unstructured datasets from disparate disclosure sources.

### BACKGROUND

In today's electronic environment, software applications configured on computing resources are used more and more to solve everyday problems. However, and with the advent of all these software applications, it becomes difficult for developers to know if a new software applications needs to be newly generated or can be re-used from other purposes or from other development teams. Further, and with these software applications, it becomes important for developers to know if the software applications have already been generated before and are protected by property rights (which may be indicated by various unstructured datasets from disparate disclosure sources, like different entities, property holders, and/or the like), and thus, cannot be used without proper licensing. Therefore, a system that can automatically, efficiently, and dynamically correlate data from unstructured datasets (e.g., software application metadata, entity datasets, and/or the like), from disparate disclosure sources.

Applicant has identified a number of deficiencies and problems associated with correlating of from unstructured datasets from disparate disclosure sources automatically, efficiently, and dynamically. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for automatically correlating data of unstructured datasets from disparate disclosure sources.

In one aspect, a system for automatically correlating data of unstructured datasets from disparate disclosure sources is provided. In some embodiments, the system may comprise: a memory device with computer-readable program code stored thereon; at least one processing device operatively coupled to the memory device and at least one communication device, wherein executing the computer-readable code is configured to cause the at least one processing device to: identify application metadata associated with at least one application; access at least one database comprising a plurality of unstructured datasets; input the application metadata and the plurality of unstructured datasets to a graph synthesizer; generate, by the graph synthesizer, a correlation score between the application metadata and the plurality of unstructured datasets; and determine, based on the correlation score, the at least one application is highly correlated to at least one unstructured dataset of the plurality of unstructured datasets or is low correlated to the plurality of unstructured datasets.

In some embodiments, the at least one database comprises the plurality of unstructured datasets from a plurality of external and disparate data sources. In some embodiments, the at least one database comprises a plurality of patent documents associated with a plurality of inventions or a plurality of entities.

In some embodiments, the correlation score comprises an aggregation of a graph based score and a correlation scoring model.

In some embodiments, the at least one application is low correlated to the plurality of unstructured datasets, and wherein executing the computer-readable code is further configured to cause the at least one processing device to: apply the application metadata to an intent generator engine; determine, by the intent generator engine, an intent of the at least one application; identify at least one relevant external dataset based on the intent of the at least one application; and determine, by a difference engine, at least one difference between the at least one relevant external dataset and the at least one application. In some embodiments, the intent generator engine is a transformer neural network and the difference detector is a transformer neural network.

In some embodiments, executing the computer-readable code is further configured to cause the at least one processing device to: train a metadata extractor by inputting data associated with the correlation score generated by the graph synthesizer to the metadata extractor at a first instance; and train the metadata extractor by inputting the at least one difference determined by the difference engine to the metadata extractor at a second instance. In some embodiments, the data associated with the correlation score comprises a graph based score and the graph based score comprises a count between a plurality of nodes and at least one edge within a graph based on the at least one application and the plurality of unstructured datasets. In some embodiments, the data associated with the correlation score comprises a correlation scoring model and the correlation scoring model comprises a transformer neural network configured to vectorize the application metadata and the plurality of unstructured datasets. In some embodiments, executing the computer-readable code is further configured to cause the at least one processing device to: output, by the trained metadata extractor, explainability metadata of the at least one application; generate a validation interface component comprising the explainability metadata; transmit the validation interface component to a user device; and trigger a configuration of a graphical user interface of the user device based on transmitting the validation interface component.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for automatically correlating data of unstructured datasets from disparate disclosure sources, in accordance with an embodiment of the disclosure;

FIG. 2 illustrates a process flow for automatically correlating data of unstructured datasets from disparate disclosure sources, in accordance with an embodiment of the disclosure;

FIG. 3 illustrates a process flow for determining at least one difference between at least one relevant external dataset and at least one application, in accordance with an embodiment of the disclosure;

FIG. 4 illustrates a process flow for triggering a configuration of a graphical user interface with a generated validation interface component, in accordance with an embodiment of the disclosure;

FIG. 5 illustrates a flow diagram for automatically correlating data of unstructured datasets from disparate disclosure sources, in accordance with an embodiment of the disclosure;

FIG. 6 illustrates an exemplary flow diagram for completing a graph based scoring method, in accordance with an embodiment of the disclosure;

FIG. 7 illustrates an exemplary flow diagram showing correlation model scoring and a difference engine, in accordance with an embodiment of the disclosure;

FIG. 8 illustrates an exemplary flow diagram for an intent generator engine and exemplary intents for at least one application, in accordance with an embodiment of the disclosure; and

FIG. 9 illustrates an exemplary flow diagram and exemplary tables for a metadata extractor, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In today's electronic environment, software applications configured on computing resources are used more and more to solve everyday problems. However, and with the advent of all these software applications, it becomes difficult for developers to know if a new software applications needs to be newly generated or can be re-used from other purposes or from other development teams. Further, and with these software applications, it becomes important for developers to know if the software applications have already been generated before and are protected by property rights (which may be indicated by various unstructured datasets from disparate disclosure sources, like different entities, property holders, allowed patents associated with different entities and/or inventions, and/or the like), and thus, cannot be used without proper licensing. Therefore, a system that can automatically, efficiently, and dynamically correlate data from unstructured datasets (e.g., software application metadata, entity datasets, and/or the like), from disparate disclosure sources (e.g., internal databases, internal repositories, external databases, external repositories, multiple external sources, and/or the like).

Accordingly, the present disclosure provides for the identification of application metadata associated with at least one application; the access of at least one database comprising a plurality of unstructured datasets; the input of the application metadata and the plurality of unstructured datasets to a graph synthesizer; the generation, by the graph synthesizer, of a correlation score between the application metadata and the plurality of unstructured datasets; and the determination, based on the correlation score, that the at least one application is highly correlated to at least one unstructured dataset of the plurality of unstructured datasets or is low correlated to the plurality of unstructured datasets. Additionally, and in some embodiments, and wherein the at least one application is low correlated to the plurality of unstructured datasets, the present disclosure provides for the application of the application metadata to an intent generator engine; the determination, by the intent generator engine, of an intent of the at least one application; the identification of at least one relevant external dataset based on the intent of the at least one application; and the determination, by a difference engine, of at least one difference between the at least one relevant external dataset and the at least one application.

In other words, the disclosure provides a system that may identify novel and non-novel features in software applications. For instance, and in some embodiments, the system may identify potential patent infringement within the software applications and novel features within the software applications. The system comprises a graph synthesizer that may be configured to extract entities and keywords from disparate datasets, extract software application metadata, access patent databases using NLP technology and construct an initial knowledge graph which is then used to generate semantic connections and weightages. The system may further use graph based search techniques to analyze the path for each application to the patent claims and determine the correlation scoring. The system may further comprise a correlation scoring model that vectorizes the application entities, source code, and patent claims to determine correlations between each. Based on the graph based score and the correlation scoring model, the system may analyze a combined scoring from both to generate a list of the highly correlated software applications to patents. Similarly, the system may generate a list of non-correlated or low correlated software applications to patents. The system may use a transformer neural network to generate intents for the no or low-correlated software applications, and to identify the novel ideas from the software applications and associated public information (e.g., internet sources that are correlated based on the identified intent) of the software applications. Further, the system may pull the graph based scoring paths and attention weights from the multi-head attention component of correlation scoring model to input to a metadata extractor component.

What is more, the present disclosure provides a technical solution to a technical problem. As described herein, the technical problem includes the automatic correlation between unstructured datasets from disparate disclosure sources. For instance, the technical solution described herein provides a technical solution to the problem of determining whether software applications need to be newly generated, or can be recycled from past or historical software applications (which will conserve computing resources, time, network resources in development team communications to develop new applications), whether the new applications or pre-existing applications are novel from current prior applications, sources, and/or the like, and thus, can be protected from future misappropriation or mis-use. Thus, the technical solution presented herein allows for the accurate, efficient, automatic, and dynamic correlation of unstructured datasets (e.g., between software applications and disparate patent sources, known prior art sources, scientific sources, and/or the like) from disparate disclosure sources. In particular, the disclosure provided herein is an improvement over existing solutions to the correlation between non-uniform and unstructured datasets comprising software application metadata and related or unrelated datasets, documents, and/or the like, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

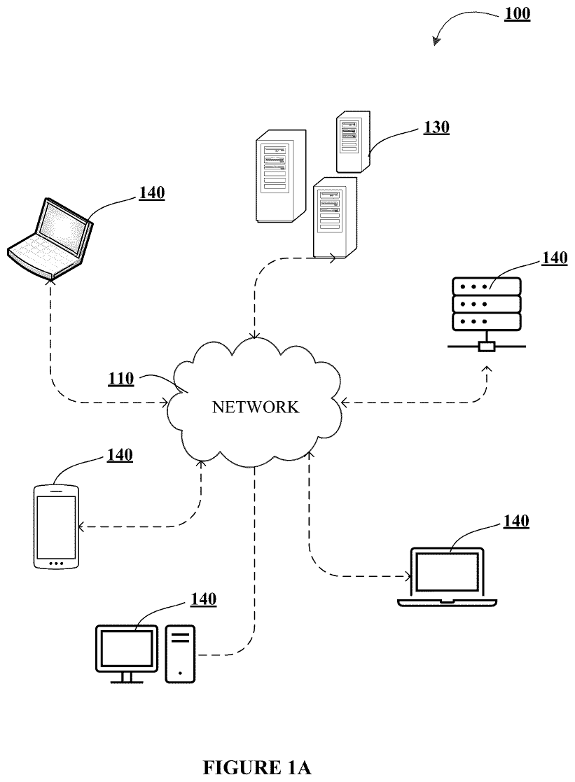

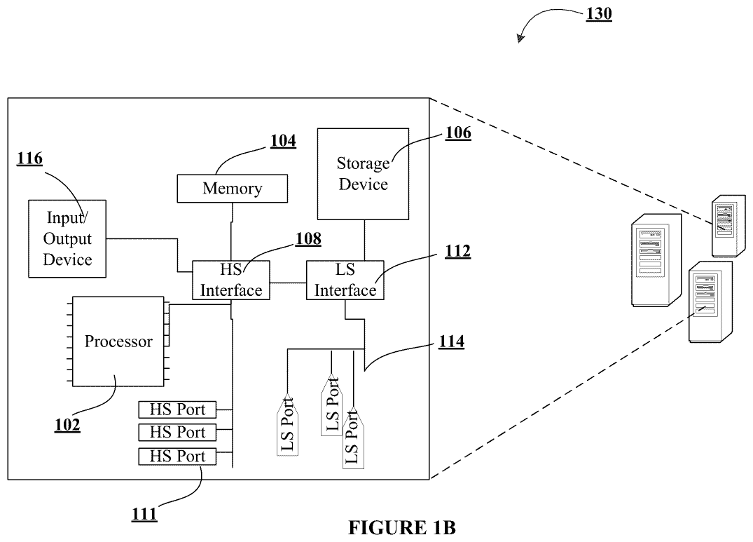

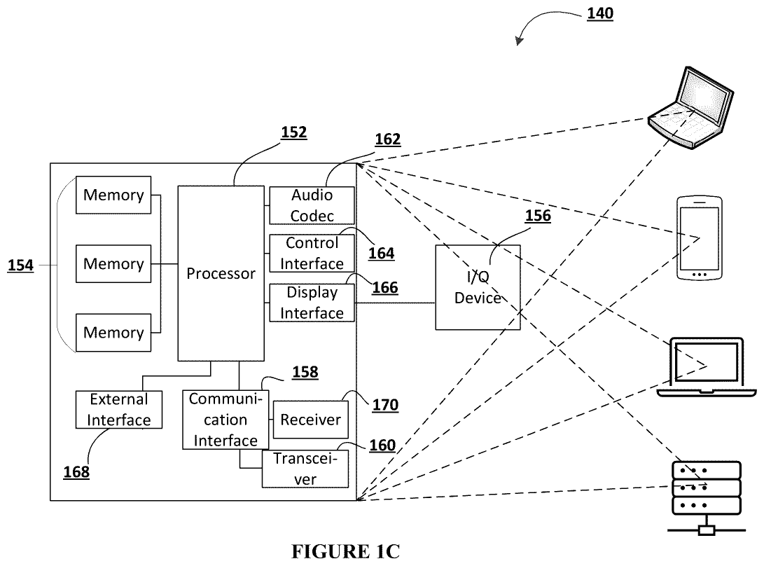

FIGS. 1A-1C illustrate technical components of an exemplary distributed computing environment for automatically correlating data of unstructured datasets from disparate disclosure sources 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

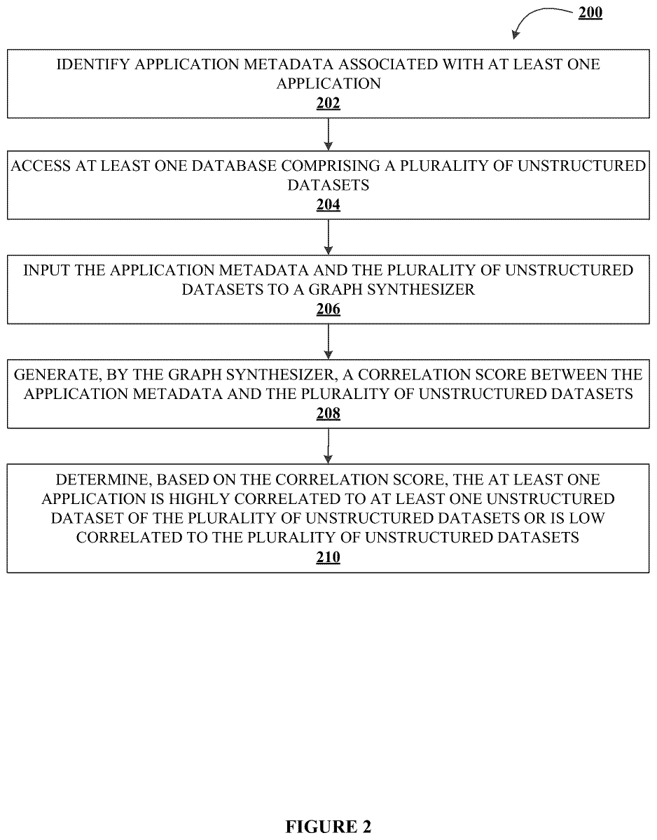

FIG. 2 illustrates a process flow 200 for [ ], in accordance with an embodiment of the disclosure. In some embodiments, a system (e.g., similar to one or more of the systems described herein with respect to FIGS. 1A-1C) may perform one or more of the steps of process flow 200. For example, a system (e.g., the system 130 described herein with respect to FIG. 1A-1C) may perform the steps of process 200.

As shown in block 202, the process flow 200 may include the step of identifying application metadata associated with at least one application. For instance, the system may identify at least one application and its application metadata based on the system receiving an application identifier (such as from a user account associated with the system that wishes to analyze the application as part of the process described herein), identifying an application identifier from a database (such as from an internal database, an unstructured database comprising application metadata organized by application identifiers, and/or the like), and/or the like. In some embodiments, the application metadata for each application associated with the system may comprise application-specific information, such as but not limited to application architecture blueprint(s), application metadata report(s)/output report(s), design document(s), source code(s), object code(s), and/or the like. In some embodiments, the application metadata may be accessed and/or collected by the system automatically and upon identifying the application identifier associated with the application the system will analyze by the processes described herein. In some embodiments, the system may be configured to analyze a plurality of applications and their application metadata in parallel and in real time or near real time via the processes described herein.

As shown in block 204, the process flow 200 may include the step of accessing at least one database comprising a plurality of unstructured datasets. For instance, the system may access at least one database, such as a database comprising unstructured datasets from an external entity (or entities) external to a network associated with the system; an unstructured database comprising datasets, documents, files, and/or the like, that is internal to a network associated with the system (e.g., such as a database generated by an entity associated with the network), and/or the like. In some embodiments, the unstructured database may comprise unstructured datasets of a specific type, such as but not limited to unstructured datasets of patent documents, patent claims, United States granted patents, internal granted patents, and/or the like. In some embodiments, the unstructured datasets may comprise patent applications currently pending at a regional level (United States), internationally, and/or the like. In some embodiments, the at least one database comprising a plurality of unstructured datasets may comprise documents, files, source code, and other such application metadata associated with one application or a plurality of applications.

In some embodiment, the system may access the at least one database and collect a specified type of unstructured datasets (such as those unstructured datasets associated with an entity identifier such as a competitor identifier, unstructured datasets associated with a particular object, invention, application, and/or the like) based on the application metadata associated with the at least one application. In some embodiments, the system may access the at least one database and collect each of the unstructured datasets from the at least one database to compare to the application metadata in the following process steps.

In some embodiments, the at least one database may comprise a plurality of unstructured datasets from a plurality of external and disparate data sources. For instance, the at least one database may comprise a plurality of unstructured datasets that were collected from at least one external sources (e.g., external entities outside a network associated with the system), disparate data sources (e.g., a plurality of disparate entities that each generated their own disparate datasets, such as but not limited to patent documents that were generated by multiple, different entities, and that each may comprise their own words, language, claim language, inventions, formats, figures, and/or the like), and/or the like. In some embodiments, the at least one database comprises a plurality of patent documents associated with a plurality of inventions or a plurality of entities. In some embodiments, the at least one database may comprise unstructured datasets that were generated from disparate entities, but collected from a singular source, such as a singular internet source, a singular patent office database, and/or the like. In some embodiments, the at least one database may comprise unstructured datasets collected from a plurality of disparate entities, a plurality of sources, and/or the like.

As shown in block 206, the process flow 200 may include the step of inputting the application metadata and the plurality of unstructured datasets to a graph synthesizer. For instance, the system may input the application metadata and the plurality of unstructured datasets to a graph synthesizer, whereby the graph synthesizer is configured to generate a correlation score which may be used to determine which of the unstructured datasets, if any, are highly correlated (very similar to or the same) as the application metadata. In some embodiments, the graph synthesizer may be configured to generate a graph based scoring and/or a correlation model scoring using two different methods, whereby each graph based scoring and correlation model scoring may be used to generate the correlation score described hereinbelow.

In some embodiments, and based on the application of the application metadata and the unstructured datasets to the graph synthesizer, the system—via the graph synthesizer—may determine the correlation between each of the unstructured datasets and the application metadata. In some embodiments, the graph synthesizer may extract entities, keywords, and/or the like, from the application metadata (e.g., application architecture blueprint(s), design document(s), source repositories, and/or the like) using a natural language processing (NLP) component and techniques to populate a knowledge graph, whereby in some such embodiments each piece of application metadata or a collection of application metadata may be used to generate nodes within the knowledge graph. Further, and in some embodiments, the knowledge graph generated by the graph synthesizer may further comprise domain ontology to determine semantic connections and weightage between each of the application metadata nodes. In some embodiments, the graph synthesizer may extract entities, keywords, claim limitations, and/or the like, using a natural language processing (NLP) component to populate the knowledge graph, that indicates the relationships between each of the entities, keywords, and/or the like from the unstructured datasets (e.g., the patent documents), whereby the unstructured datasets data may be used to generate one or more nodes within the knowledge graph. Further, and in some embodiments, the graph synthesizer may be configured to further populate the knowledge graph with edges between each of the nodes to indicate the similarities and differences between the application metadata and the unstructured dataset data. For example, and in some such embodiments, the similarities within the knowledge graph may be indicated by nodes that are connected by the least number of edges, and the differences may be indicated by the nodes that are connected by the greatest number of edges. Thus, and in some embodiments, the graph synthesizer may analyze the knowledge graph for application metadata (and their associated applications) closely relevant to the patents using graph based search techniques and generate the ontology based weighted score for correlation. Thus, and in some embodiments, the data associated with the correlation score comprises a graph based score and the graph based score comprises a count between a plurality of nodes and at least one edge within a graph based on the at least one application and the plurality of unstructured datasets.

Additionally, and in some embodiments, the graph synthesizer may comprise a correlation scoring model which may vectorize the application entities, source code, patent claims, and/or the like to determine the correlation using a transformer neural network. Thus, and in some embodiments, the data associated with the correlation score comprises a correlation scoring model and the correlation scoring model comprises a transformer neural network configured to vectorize the application metadata and the plurality of unstructured datasets.

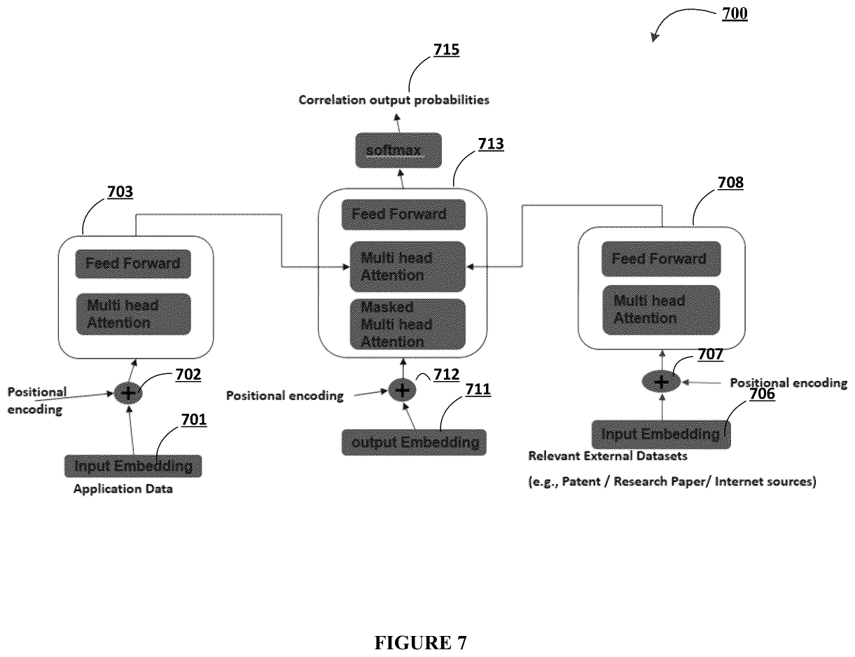

Such an embodiment for a correlation scoring model is further shown and described in further detail hereinbelow with respect to FIG. 7.

As shown in block 208, the process flow 200 may include the step of generating, by the graph synthesizer, a correlation score between the application metadata and the plurality of unstructured datasets. For example, the system may generate—based on the graph synthesizer and its output(s)—a correlation score between the applications of the application metadata and unstructured datasets (e.g., the patents indicated by the unstructured datasets). For instance, and in some embodiments where the graph synthesizer comprises a correlation scoring model and the graph based score, the system may aggregate the scores from the correlation scoring model and the graph based score to generate the correlation score. In some embodiments, the aggregation of the score from the correlation scoring model and the graph based score may comprise an average of the scores from the correlation scoring model and the graph based score, a combination (e.g., an addition) of the scores from the correlation scoring model and the graph based score, and/or the like.

Thus, and in some such embodiments, the correlation score may be an overall score indicating the correlation between the application(s) of the application metadata and the patent documents of the at least one database. In some embodiments, the higher the correlation score, the more correlated the application(s) is to at least one patent document (and the more likely an infringement is present). In some embodiments, the lower the correlation score, the less correlated or not correlated the application(s) is to any of the patent documents from the unstructured database.

As shown in block 210, the process flow 200 may include the step of determining, based on the correlation score, the at least one application is highly correlated to at least one unstructured dataset of the plurality of unstructured datasets or is low correlated to the plurality of unstructured datasets. For example, the system may determine whether any of the applications analyzed by the system are highly correlated to any of the patent documents of the unstructured database or whether the applications are low or not correlated at all to any of the patent documents (and thus, do not infringe any of the patent documents).

In some embodiments, the correlation score may comprise a numerical value, such as but not limited to a whole number, a percentage, and/or the like, which may be compared to a correlation threshold (or a plurality of correlation thresholds) to determine whether the confidence score meets or exceeds the correlation threshold. In some embodiments, and where the confidence score meets or exceeds a low confidence threshold, but not a high confidence threshold, then the system may determine that the application associated with the confidence score is low correlated. In some embodiments, and where the confidence score doesn't exceed either the low confidence threshold or the high confidence threshold, then the system may determine the application associated with the confidence score is not correlated at all. In some embodiments, and where the confidence score meets both the low confidence threshold and the high confidence threshold, then the system may determine the application associated with the confidence score is high correlated. By way of non-limiting example, and where the application associated with a confidence score that meets or exceeds at least the high threshold, then the system may determine that the application is likely infringing a patent associated with the unstructured dataset.

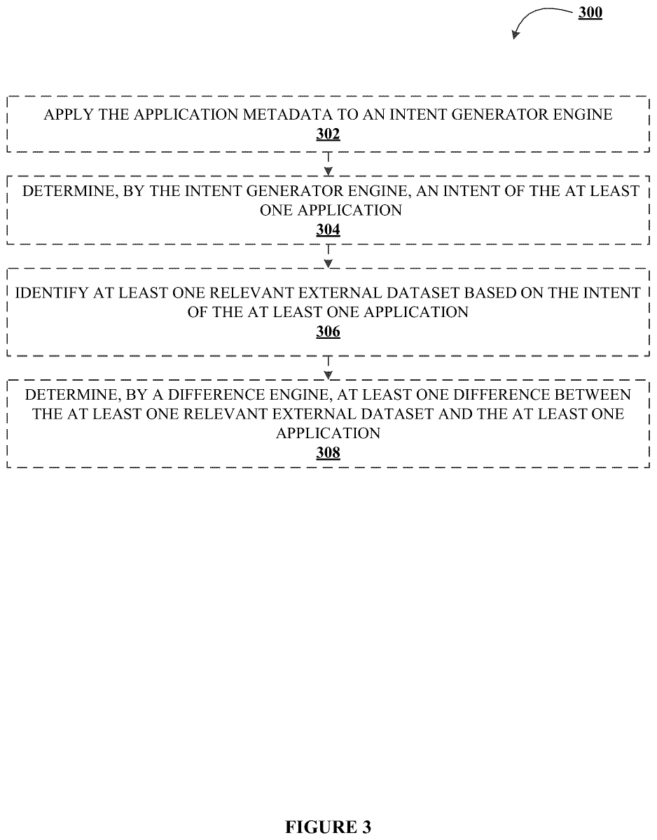

FIG. 3 illustrates a process flow 300 for determining at least one difference between at least one relevant external dataset and at least one application, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300.

In some embodiments, and as shown in block 302, the process flow 300 may include the step of applying the application metadata to an intent generator engine. For instance, the system may apply the application metadata identified in FIG. 2 to an intent generator engine for further processing and analysis. In some embodiments, and before applying the application metadata to the intent generator engine, the system may determine the applications associated with the application metadata input to the intent generator engine is low correlated or not correlated at all to unstructured datasets of the at least one database. For instance, and upon determining that the application associated with the application metadata does not infringe any patents from the at least one database, the system may apply the associated application metadata to an intent generator, which is configured to determine the intent, purpose, and/or the like of the associated application. In some such embodiments, the intent generator may be a transformer neural network configured to determine the purpose behind the associated application(s). In some such embodiments, the intent of each application applied the intent generator engine may be used by the system to determine differences between the associated application(s) and other unstructured datasets (e.g., other documents, public information, articles, publicly available information, and/or the like), which is described in further detail below.

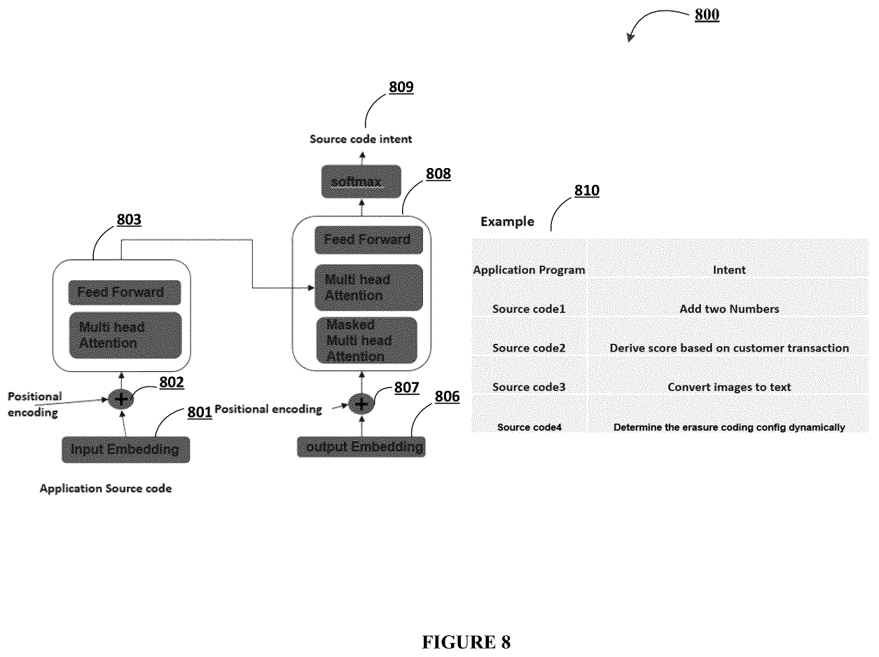

Thus, and in some such embodiments, the application of the application metadata to the intent generator engine may comprise an inputting of the application source code to the intent generator engine. In some embodiments, the application metadata applied to the intent generator may comprise the transformer neural network that is configured with positional encoding, multi-head attention, masked multi head attention, and feed forward components to determine the source code intent behind each application (and their application source code). Such an embodiment is shown and described below with respect to FIG. 8.

In some embodiments, and as shown in block 304, the process flow 300 may include the step of determining, by the intent generator engine, an intent of the at least one application. For example, the system may determine—using the intent generator engine—an intent behind each application applied to the intent generator engine. Thus, and in some embodiments, the intent of the at least one application may comprise the underlying purpose behind the application source code, the difference between an input and output of the object code associated with the application source code, and/or the like.

In some embodiments, and as shown in block 306, the process flow 300 may include the step of identifying at least one relevant external dataset based on the intent of the at least one application. For example, the system may identify at least one relevant external dataset (which may be unstructured, comprise a plurality of formats, keywords, phrases, entities, sources, and/or the like), from an external source, an external database, an internal database comprising datasets collected from external sources outside the network associated with the system, and/or the like. In some embodiments, the external dataset may comprise a scientific article, a patent application, an expired patent, an article, a video, a photograph, a source code file, an open source file, and/or the like. As used herein, the external dataset identified based on the intent of the at least one application may refer to any piece of information that is publicly known or could be publicly known and is relevant or related to the intent of the application. In some embodiments, the system may use the intent determined for the application metadata and search for relevant external datasets from the internet (e.g., an external source), an internal database that is generated by collecting historical external sources by the system, an external database (such as an external database generated and operated by an external source such as but not limited to a scientific entity, an open source entity, and/or the like), and/or the like.

In some embodiments, the intent determined by the intent generator engine may be used by the system to search for the same keywords from the determined intent to collect external datasets. Thus, and based on the keywords from the intent, the system may collect relevant or related external datasets with the same keywords or similar keywords to compare to the associated application and its metadata.

In some embodiments, and as shown in block 308, the process flow 300 may include the step of determining, by a difference engine, at least one difference between the at least one relevant external dataset and the at least one application. For example, and in some such embodiments, the system may determine—using a difference engine—to detect the differences between the application associated with the determined intent and the external datasets. As used herein, the difference engine refers to a difference detector neural network (e.g., a transformer neural network), which comprises an embodiment that is shown and described below with respect to FIG. 7. Thus, and in some embodiments, the difference engine may determine novel aspects, or new features, in the application and/or its application metadata, as compared to the external datasets analyzed by the difference engine. In some such embodiments, the novel feature(s) may be used for selection and/or drafting of patent applications for the associated application, which may in turn be used to get the associated patent application granted. Thus, and in some embodiments, the system may determine at least one difference between the relevant external dataset (e.g., scientific reports/papers, public information, non-patent documents, patent applications, and/or the like) and the at least one application. And such a difference may indicate that the at least one application is novel and/or non-obvious based on determining each of the differences between the application and the non-patent documents.

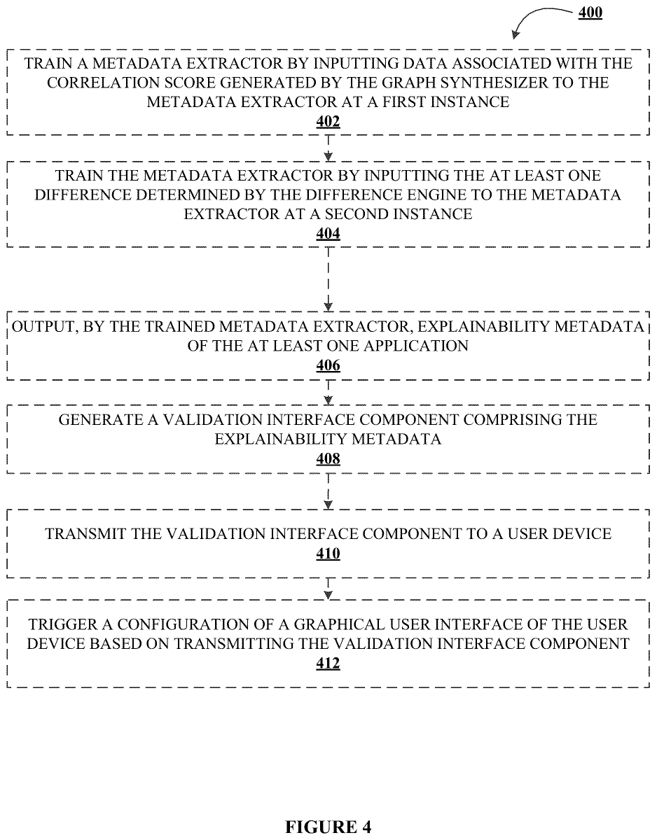

FIG. 4 illustrates a process flow 400 for triggering a configuration of a graphical user interface with a generated validation interface component, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400.

In some embodiments, and as shown in block 402, the process flow 400 may include the step of training a metadata extractor by inputting data associated with the correlation score generated by the graph synthesizer to the metadata extractor at a first instance. For example, and in some embodiments, the system may train a metadata extractor by inputting (or applying) the data associated with correlation score described above with respect to FIGS. 2 and 3, such that the metadata extractor is configured to pull the graph based scoring paths, the correlation scoring models, and the difference engine attention weights. In some embodiments, the metadata extractor may be configured to determine which application metadata is important, novel, non-obvious, and/or the like as compared to the external datasets. Thus, and in some such embodiments, the metadata extractor module may be configured to determine which application metadata is important, novel, non-obvious, and/or the like, for determining if the application can have its own patent granted if a patent application were filed.

Additionally, and in some embodiments, the phrase “at a first instance” does not necessarily mean that at a first instance occurs before a second instance, a third instance, and/or the like, and/or in parallel to the second instance, third instance, and/or the like. For instance, and in some embodiments, the phrase at a first instance as compared to a second instance may indicate that the first instance and the second instance occur at different times.

In some embodiments, and as shown in block 404, the process flow 400 may include the step of training the metadata extractor by inputting the at least one difference determined by the difference engine to the metadata extractor at a second instance. For instance, and in some such embodiments, the system may train the metadata extractor by inputting the at least one determined difference of FIG. 3 to the metadata extractor at least at a second instance. In some embodiments, the system may continue to train the metadata extractor by inputting the difference(s) determined by the difference engine in real time or near real time to the difference(s) being determined.

In some embodiments, and as shown in block 406, the process flow 400 may include the step of outputting, by the trained metadata extractor, explainability metadata of the at least one application. For example, and in some such embodiments, and upon training the metadata extractor, the metadata extractor may generate—using the metadata extractor—explainability metadata that may be used for validation of the contents of the explainability metadata which may explain the novelty, non-obviousness, and non-infringement of the application. Thus, and in some embodiments, the explainability metadata may be used by the system to explain each of the steps and outputs generated in FIGS. 2, 3, and 4.

In some embodiments, and as shown in block 408, the process flow 400 may include the step of generating a validation interface component comprising the explainability metadata. For example, and in some such embodiments, the system may generate a validation interface component which comprises a packet of data comprising the explainability metadata, and which may be used to configure a graphical user interface to show the data and information of the explainability metadata. Thus, and in some such embodiments, the validation interface component and its associated explainability metadata may be used for user validation of correlation for the application and the identified related unstructured datasets (e.g., patents), external datasets (e.g., public information, and/or the like), and/or the like. In this manner, and in some embodiments, the validation interface component may be transmitted, over a network, to a user device associated with the application analyzed by the system and associated with the explainability metadata, such that a user of the user device may indicate (such as by submitting user input at the user device) whether a patent application should be filed on the software application.

In some embodiments, and as shown in block 410, the process flow 400 may include the step of transmitting the validation interface component to a user device. For instance, and in some such embodiments, the system may transmit the validation interface component to an identified user device over a network, whereby the user device may be identified by the system based on a user account identifier associated with the user device. In some such embodiments, the system may identify user account identifiers that are associated with the application that the explainability metadata is generated for, whereby the user account identifiers may be associated with user accounts that control, operate, manage, and/or generated the application.

In some embodiments, and as shown in block 412, the process flow 400 may include the step of triggering a configuration of a graphical user interface (GUI) of the user device based on transmitting the validation interface component. For instance, and in some such embodiments, the transmission of the validation interface component to the user device may automatically trigger the configuration of the GUI user device to show the data of the explainability metadata.

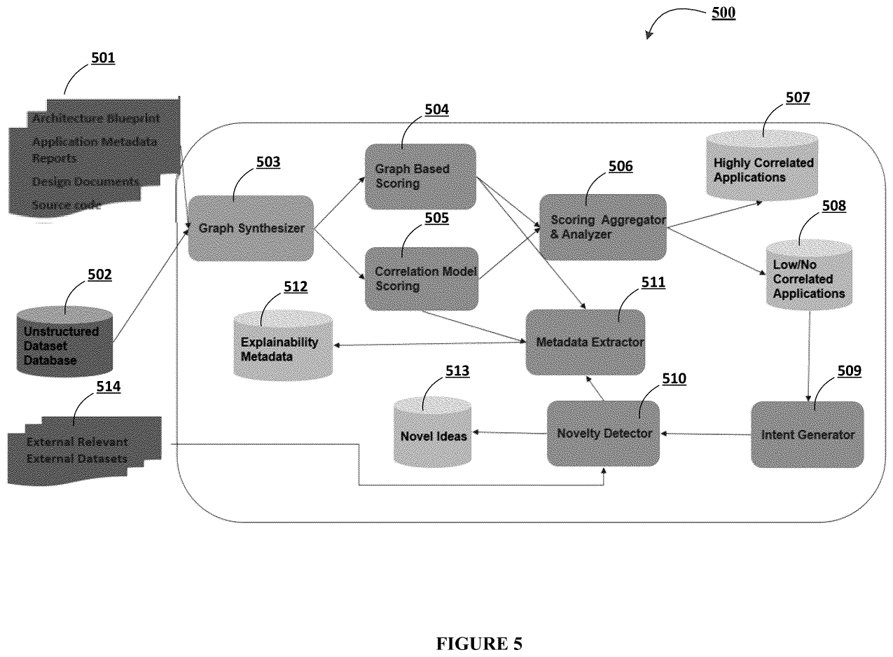

FIG. 5 illustrates a flow diagram 500 for automatically correlating data of unstructured datasets from disparate disclosure sources, in accordance with an embodiment of the disclosure. In some embodiments, a system (e.g., similar to one or more of the systems described herein with respect to FIGS. 1A-1C) may perform one or more of the steps of flow diagram 500. For example, a system (e.g., the system 130 described herein with respect to FIG. 1A-1C) may perform the steps of flow diagram 500.

For instance, and as shown in flow diagram 500, the processes described hereinabove are shown as a comprehensive and full process, which may occur as a whole in some instances and embodiments. For instance, and in some embodiments, the system—using a graph synthesizer 503—may collect application metadata from a database 501 (which may comprise architecture blueprints, application metadata reports, design documents, source code, and/or the like) associated with an application or a plurality of applications within a network or associated with a network (e.g., the network associated with the system, the network associated with entity that owns, operates, licenses, uses, and/or the like, of the application(s) and the application metadata stored in the database 501). In some embodiments, the graph synthesizer 503 may additionally collect unstructured datasets from an unstructured dataset database 502, whereby the unstructured datasets may comprise data, documents, files, and/or the like associated with one or more patents, entities and their intellectual property, files, and/or the like. In some embodiments, and upon collecting the application metadata and unstructured datasets, the graph synthesizer 503 may generate a graph based scoring 504 and a correlation model scoring 505, which in turn may be used to generate a correlation score (which may be generated by the scoring aggregator & analyzer 506 component based on aggregating or combining the graph based score and the correlation model score from 504 and 505, respectively).

Further, and upon determining the correlation score by the scoring aggregator & analyzer 506, the system may determine whether the associated application of the correlation score is highly correlated (i.e., and thus, should be sorted into the highly correlated applications 507) with the documents from the unstructured dataset database (e.g., patents and their claims, and thus, is likely infringing), or whether the associated applications of the correlation score is low or not correlated (i.e., and thus, should be sorted into the low/no correlated applications 508) with the documents from the unstructured dataset database (e.g., is not or is lowly correlated to the patents and their claims, and thus, is unlikely to be infringing).

Additionally, and based on the low/no correlated applications 508, the system may input these low/no correlated apps 508 to an intent generator (i.e., an intent generator engine), which is configured to determine the intents of the no/low correlated applications 508. In some embodiments, and upon determining the intents of the application analyzed by the intent generator engine, the system may use the determined intent(s) to determine the differences between the application at issue and external sources (e.g., from the external relevant external datasets 514) which were collected based on their relevancy to the determined intents. In some such embodiments, the novelty detector 510 may also be referred to as the difference engine, which may further comprise a transformer neural network and is configured to determine the new and novel features from the application analyzed as compared to the external datasets (e.g., publicly available information, scientific articles, articles, videos, internet sources, expired patents, patent applications, and/or the like). Upon determine the novel features by the novelty detector 510, the system may store the novel features in a database configured to store these novel ideas for future use (such as for future patent applications, and/or the like) in a novel ideas database 513. In some embodiments, and upon determining the novel features, the system may input these novel features to a metadata extractor 511, which may collect data such as but not limited to the graph based score, correlation model score, the novel features, and/or the like. Further, and in some embodiments, the metadata extractor 511 may—after receiving and being trained on the graph based score, correlation model score, the novel features, and/or the like—generate the explainability metadata, which may be used for confirming the graph based score, the correlation model score and the novel features by a user associated with the application.

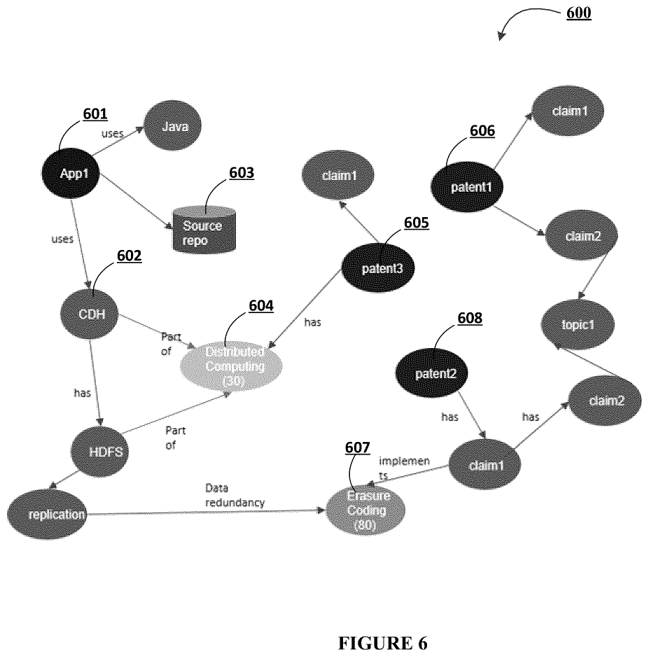

FIG. 6 illustrates an exemplary diagram 600 for completing a graph based scoring method 600, in accordance with an embodiment of the disclosure. In some embodiments, a system (e.g., similar to one or more of the systems described herein with respect to FIGS. 1A-1C) may perform one or more of the steps of diagram 600. For example, a system (e.g., the system 130 described herein with respect to FIG. 1A-1C) may perform the steps of diagram 600.

For instance, and as shown in diagram 600, the system may be configured—using the graph synthesizer—to generate a knowledge graph like that shown in diagram 600. For example, and as shown in the knowledge graph of diagram 600, the software application 1 601 may be shown as a node within the knowledge graph, each other node within the knowledge graph may indicate features of the application, features of patents from the unstructured datasets (such as patent 3 605, patent 1 606, and/or the like), and relational nodes indicating the shared features between the patents and the application (e.g., application 1). For instance, and as shown as the node indicating Distributed Computing 604, which shows 3 to 4 edges between the Application 1 601 and Patent 3, where the three edges are indicated as the application 1 “using” CDH which is a “part of” Distributed Computing 604, which patent 3 605 “has.” The 4 edges between Application 1 601 and Patent 3 are indicated as the application 1 “using” CDH which “has” HDFS, where the HDFS is a part of Distributed Computing 604, which patent 3 605 “has.” However, and importantly, by having edges between the application 1 601 and patent 3 comprising “part of,” and not a full implementation (which could indicate that the node is part of the claims within the patent like that shown by the edge connected patent 2's claim 1 to erasure coding), the application 1 601 may show a low correlation to patent 3 605 as the claims are not infringed upon by only an edge(s) indicating that patent 3 has Distributed Computing 604 which application 1 601 only uses a part of within its dataset (e.g., within its description). In contrast to patent 3, the edges between patent 2 608 and application 1 601 comprise 6 edges connecting application 1 601 to CDH 602 by the application “using” CDH, which “has” HDFS, and whereby the HDFS is a replication or equivalent for “data redundancy” of erasure coding 607, whereby the erasure coding 607 is implemented on claim 1 of patent 2 608. Thus, and as shown in the knowledge graph, and by the use of claim 1 of patent 2 608 implementing the same erasure coding 607 of application 1 601, the graph synthesizer may determine the application 1 is highly correlated to patent 2. Further, and as shown via the edges between application 1 601 and patent 1 606, the graph synthesizer may determine the application 1 601 and patent 1 606 have no correlation.

FIG. 7 illustrates an exemplary flow diagram 700 showing correlation model scoring and a difference engine, in accordance with an embodiment of the disclosure. In some embodiments, a system (e.g., similar to one or more of the systems described herein with respect to FIGS. 1A-1C) may perform one or more of the steps of flow diagram 700. For example, a system (e.g., the system 130 described herein with respect to FIG. 1A-1C) may perform the steps of flow diagram 700.

As shown in flow diagram 700, a correlation model scoring, and difference engine are shown. For instance, and starting at the input encoding step 701 comprising the application data (application metadata), the transformer neural network shown in flow diagram 700 may vectorize the words from the application metadata by input embedding the application metadata to group similar words with similar meanings together and each word is assigned a respective weight or value. Additionally, and to resolve the issue of context changes within each sentence comprising (or context changes within source code lines), the transformer neural network may apply a positional encoding 702 step comprising vectors to give context according to the position in the sentence (or within the source code line).

Upon vectorizing the application metadata using the input embedding 701 and the positional encoding 702, the transformer neural network input the positional encoding output to the encoder block 703 comprising the multi head attention component and the feed forward component. For example, the multi head attention component may take the output from the positional encoding component 702 (the application metadata that has been vectorized based on the meaning of the word and based on the context of the word), and determine how relevant the word is with respect to other words in the sentence or line of code by generating multiple attention vectors per word to determine the contextual relationship between the words in the sentence/line of code. Further, and upon generating the multiple attention vectors for each word, the transformer neural network may take a weighted average between the multiple attention vectors to determine the overall attention vector for each word in the sentence of line of code.

Additionally, and as shown in the encoder block 703, the overall attention vector for each word may be fed to the feed forward neural network component, and the feed forward neural network component may transform the attention vectors for the sentence/line of code to an input for the multi-head attention component at encoder block 713. In some embodiments, such a transformation may comprise a reformatting of the attention vectors (e.g., a reformatting into a matrix or matrices, a graph, and/or the like), such that each attention vector may be input to the multi head attention component of encode block 713 in parallel.

Similarly, the relevant external datasets (e.g., patents, research papers, patent applications, internet sources, and/or the like may be input to an input embedding component 706 to vectorize (e.g., generating vectors of the words) the words within the relevant external datasets. Additionally, and upon vectorizing the words within the relevant external datasets, the transformer neural network may input the vectors of the words to the positional encoding component 707 to determine the context of each word within each sentence (or lines of code) within the external datasets. Similarly to encoder block 703, encoder block 708 may act in the same manner using its multi head attention component and feed forward component to output attention vectors for the sentence/line of code within the external datasets to an input for the multi-head attention component at encoder block 713.

As shown in output embedding component 711, the transformer neural network may use known variables (e.g., such as a known source code line/application metadata from a previous application that is intended to translate to an output of an equivalent sentence, disclosure, claim, and/or the like from an external dataset) to train encoder block and the decoder block by inputting the known variables or known words to the output embedding component 711, which vectorizes the known words with their known meanings, and the positional encoding component 712, which updates the vectors based on their context within the sentences and/or source code lines. Upon vectorizing the known inputs by the output embedding component 711 and the positional encoding component 712, the output of the positional encoding component 712 may be fed into encoder block 713 comprising the masked multi head attention component, the multi head attention component, and the feed forward component. For instance, the encoder block 713, using the masked multi head attention component may determine a description of the source code/application metadata for one piece within the source code/application metadata and the masked multi head attention component may generate an expected next description for a next piece within the source code/application metadata on its own and by the transformer neural network hiding the next piece of the source code/application metadata. In this manner, the transformer neural network will update its matrix value by comparing the generated next description blindly and the actual description based on the non-hidden piece of source code/application metadata, and thus, this will allow the transformer neural network to learn and refine itself after multiple iterations.

Additionally, and by training the transformer neural network in encoder block 713 using the masked multi head attention component, the encoder block may receive the attention vectors output from encoder block 703 and encoder block 708 to input to the multi head attention component. The multi head attention component of encoder block 713 may analyze the vectors for each word and/or piece of each source code/application metadata and the relevant external datasets to map the pieces of the application metadata to the external datasets using the mappings and vectors analyzed and used to train the encoder block 713 from the masked multi head attention component. In this manner, the masked multi head attention component of encoder block 713 may use its training to accurately map and connect the relationships between the vectors from encoder block 703 (of the application metadata) to the vectors of encoder block 708 (of the external datasets). Now, using the feed forward component of encoder block 713, the transformer neural network may use the feed forward component on the vectors mapped and connected from encoder blocks 703 and 708 to generate output vectors into are formatted to be received by softmax layer, whereby the softmax layer may transform the vectors and their meanings and relationships into correlation output probabilities that are human-readable and show the highest probable descriptions for each piece of the application metadata. In this manner, only those descriptions from the external datasets are used for each application metadata piece, and not every description that could be linked to each application metadata piece.

FIG. 8 illustrates an exemplary flow diagram 800 for an intent generator engine and exemplary intents for at least one application, in accordance with an embodiment of the disclosure. In some embodiments, a system (e.g., similar to one or more of the systems described herein with respect to FIGS. 1A-1C) may perform one or more of the steps of flow diagram 800. For example, a system (e.g., the system 130 described herein with respect to FIG. 1A-1C) may perform the steps of flow diagram 800.

As shown in flow diagram 800, a transformer neural network is provided that may be used for the intent generator engine. For example, and similar to the processes described above with respect to the transformer neural network of flow diagram 700, application source code may be applied to an input embedding component 801, and the application source code and its pieces may be vectorized and meanings for each piece may be generated. Similar to flow diagram 700, the vectors generated by input embedding component 801 may be input to a positional encoding component 802 which may update the vectors based on context within the application software code for each vector of each piece in the software code. Upon updating the vectors by the positional encoding component 802, the transformer neural network may input the output of the positional encoding component 802 to encoding block 803 which may comprise a multi head attention component and a feed forward component. Similar to the multi head attention component of encoder blocks 703 and 708, the multi head attention block of encoder block 803 may output attention vectors for the line of code within the application source code to an input for the multi-head attention component at encoder block 808.

Additionally, and similar to the output embedding component 711 and positional encoding component 712 of FIG. 7, the output embedding component 806 and positional encoding component 807 may function in the same manner and using known variables from previous or known application source codes and determined intents. In this manner, and upon generating the vectors for the known application source codes by the output embedding component 806 and positional encoding component 807, the transformer neural network may train itself using the masked multi attention head by determining the next intents from a blind source code piece after determining an initial intent from a shown source code piece of the known variables. In this manner, and similar to the masked multi head attention component of encoder block 713, the masked multi head attention component of encoder block 808 may be used by the transformer neural network to learn and refine its learning until the encoder block 808 can accurately generate relations between the current application source code and its intents. For instance, and as shown in table 810, the transformer neural network shown in diagram 800 may generate an intent for each piece of source code analyzed by the system (e.g., source code 1 may comprise a generated intent of “adding two numbers,” source code 2 may comprise a generated intent of “deriving score based on customer transaction,” and/or the like). Thus, and similar to the functions of the feed forward component of encoder block 713, the feed forward component of encoder block 808 may be configured to output a vector that is formatted for use by the softmax component, and the softmax component may determine the most likely or most probable source code intents from all the potential source code intents generated by encoder block 808.

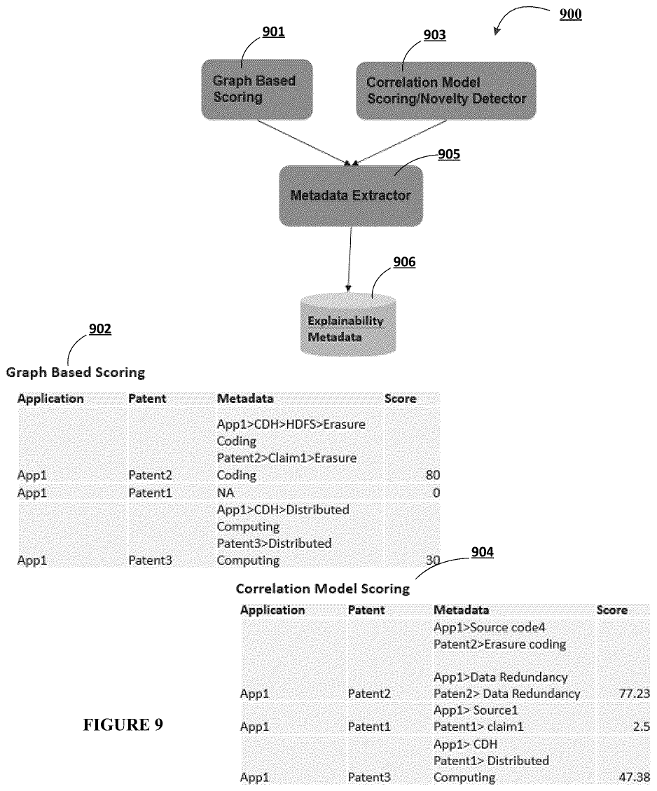

FIG. 9 illustrates an exemplary flow diagram 900 and exemplary tables 902 and 904 for a metadata extractor, in accordance with an embodiment of the disclosure. In some embodiments, a system (e.g., similar to one or more of the systems described herein with respect to FIGS. 1A-1C) may perform one or more of the steps of flow diagram 900, and generating exemplary tables 902 and 904. For example, a system (e.g., the system 130 described herein with respect to FIG. 1A-1C) may perform the steps of flow diagram 900, and generating exemplary tables 902 and 904.

As shown in flow diagram 900, a diagram for steps to generate explainability metadata is shown. For instance, and in some embodiments, the metadata extractor 905 may receive—as inputs—the graph based scoring 901 output(s) and the correlation model scoring/novelty detector 903 (difference engine) output(s). Upon receiving these inputs, the metadata extractor may generate explainability metadata for each application analyzed by the system and determined as having a no/low correlation. For example, and based on the graph based scoring component 901, a table, index, or listing of each application compared to each patent at issue is considered and shown as table 902. In table 902, and by way of example, the application at issue may be shown in comparison to each patent considered relevant (e.g., Application 1 may be compared to Patent 1, 2, and 3) and the metadata from the knowledge graph of the graph based scoring method may be shown in table 902 to indicate the relationship between the application and the associated patents. For instance, and where the metadata indicates shared nodes (e.g., Patent 1 and Patent 3), then the graph based score may be generated (e.g., 80 for Patent 1 and 30 for patent 3, which indicates a high correlation and a low correlation, respectively). However, and where no metadata is shown, which indicates relationships couldn't be found between the nodes of the application and the patent(s), then the graph based score may be zero (indicating no correlation).

Similarly, and as shown for the correlation model scoring component, a table, index, listing, and/or the like, indicating the correlation model score(s) may be generated. For instance, such a table 904 is shown and described in FIG. 9. By way of non-limiting example, table 904 may indicate the correlation model score for the application at issue and the relevant Patents, which may be based on scores and patent documents analyzed by the transformer neural network of the correlation model scoring (which is shown and described above with respect to FIG. 7.

Thus, and as shown by tables 902 and 904, the most relevant patent may be Patent 2 via both the graph based scoring method and the correlation model scoring. In contrast, the lowest and not correlated patents for application 1 are shown as patents 1 and 3. In some embodiments, and in an instance where patent 1 did not exist as a high correlation to application 1, the metadata extractor may collect the metadata of tables 902 and 904 for application 1 and patents 1 and 3, and generate the explainability metadata from the collected metadata of both tables.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for automatically correlating data of unstructured datasets from disparate disclosure sources, the system comprising:
a memory device with computer-readable program code stored thereon;
at least one processing device operatively coupled to the memory device and at least one communication device, wherein executing the computer-readable code is configured to cause the at least one processing device to:
identify application metadata associated with at least one application;
access at least one database comprising a plurality of unstructured datasets;
input the application metadata and the plurality of unstructured datasets to a graph synthesizer;
generate, by the graph synthesizer, a correlation score between the application metadata and the plurality of unstructured datasets; and
determine, based on the correlation score, the at least one application is highly correlated to at least one unstructured dataset of the plurality of unstructured datasets or is low correlated to the plurality of unstructured datasets.

2. The system of claim 1, wherein the at least one database comprises the plurality of unstructured datasets from a plurality of external and disparate data sources.

3. The system of claim 2, wherein the at least one database comprises a plurality of patent documents associated with a plurality of inventions or a plurality of entities.

4. The system of claim 1, wherein the correlation score comprises an aggregation of a graph based score and a correlation scoring model.

5. The system of claim 1, wherein the at least one application is low correlated to the plurality of unstructured datasets, and wherein executing the computer-readable code is further configured to cause the at least one processing device to:
apply the application metadata to an intent generator engine;
determine, by the intent generator engine, an intent of the at least one application;
identify at least one relevant external dataset based on the intent of the at least one application; and
determine, by a difference engine, at least one difference between the at least one relevant external dataset and the at least one application.

6. The system of claim 5, wherein the intent generator engine is a transformer neural network and the difference detector is a transformer neural network.

7. The system of claim 1, wherein executing the computer-readable code is further configured to cause the at least one processing device to:
train a metadata extractor by inputting data associated with the correlation score generated by the graph synthesizer to the metadata extractor at a first instance; and
train the metadata extractor by inputting the at least one difference determined by the difference engine to the metadata extractor at a second instance.

8. The system of claim 7, wherein the data associated with the correlation score comprises a graph based score and the graph based score comprises a count between a plurality of nodes and at least one edge within a graph based on the at least one application and the plurality of unstructured datasets.

9. The system of claim 7, wherein the data associated with the correlation score comprises a correlation scoring model and the correlation scoring model comprises a transformer neural network configured to vectorize the application metadata and the plurality of unstructured datasets.

10. The system of claim 7, wherein executing the computer-readable code is further configured to cause the at least one processing device to:
output, by the trained metadata extractor, explainability metadata of the at least one application;
generate a validation interface component comprising the explainability metadata;
transmit the validation interface component to a user device; and
trigger a configuration of a graphical user interface of the user device based on transmitting the validation interface component.

11. A computer program product for automatically correlating data of unstructured datasets from disparate disclosure sources, wherein the computer program product comprises at least one non-transitory computer-readable medium having computer-readable program code portions embodied therein, the computer-readable program code portions which when executed by a processing device are configured to cause the processor to:
identify application metadata associated with at least one application;
access at least one database comprising a plurality of unstructured datasets;
input the application metadata and the plurality of unstructured datasets to a graph synthesizer;
generate, by the graph synthesizer, a correlation score between the application metadata and the plurality of unstructured datasets; and
determine, based on the correlation score, the at least one application is highly correlated to at least one unstructured dataset of the plurality of unstructured datasets or is low correlated to the plurality of unstructured datasets.

12. The computer program product of claim 11, wherein the at least one database comprises the plurality of unstructured datasets from a plurality of external and disparate data sources.

13. The computer program product of claim 11, wherein the at least one application is low correlated to the plurality of unstructured datasets, and wherein the processing device is configured to cause the processor to:
apply the application metadata to an intent generator engine;
determine, by the intent generator engine, an intent of the at least one application;
identify at least one relevant external dataset based on the intent of the at least one application; and
determine, by a difference engine, at least one difference between the at least one relevant external dataset and the at least one application.

14. The computer program product of claim 11, wherein the processing device is configured to cause the processor to:
train a metadata extractor by inputting data associated with the correlation score generated by the graph synthesizer to a metadata extractor at a first instance; and
train the metadata extractor by inputting the at least one difference determined by the difference engine to the metadata extractor at a second instance.

15. The computer program product of claim 11, wherein the processing device is configured to cause the processor to:
output, by the trained metadata extractor, explainability metadata of the at least one application;
generate a validation interface component comprising the explainability metadata;
transmit the validation interface component to a user device; and
trigger a configuration of a graphical user interface of the user device based on transmitting the validation interface component.

16. A computer implemented method for automatically correlating data of unstructured datasets from disparate disclosure sources, the computer implemented method comprising:
identify application metadata associated with at least one application;
access at least one database comprising a plurality of unstructured datasets;
input the application metadata and the plurality of unstructured datasets to a graph synthesizer;
generate, by the graph synthesizer, a correlation score between the application metadata and the plurality of unstructured datasets; and
determine, based on the correlation score, the at least one application is highly correlated to at least one unstructured dataset of the plurality of unstructured datasets or is low correlated to the plurality of unstructured datasets.

17. The computer implemented method of claim 16, wherein the at least one database comprises the plurality of unstructured datasets from a plurality of external and disparate data sources.

18. The computer implemented method of claim 16, wherein the at least one application is low correlated to the plurality of unstructured datasets, further comprising:
apply the application metadata to an intent generator engine;
determine, by the intent generator engine, an intent of the at least one application;
identify at least one relevant external dataset based on the intent of the at least one application; and
determine, by a difference engine, at least one difference between the at least one relevant external dataset and the at least one application.

19. The computer implemented method of claim 16, further comprising:
train a metadata extractor by inputting data associated with the correlation score generated by the graph synthesizer to a metadata extractor at a first instance; and
train the metadata extractor by inputting the at least one difference determined by the difference engine to the metadata extractor at a second instance.

20. The computer implemented method of claim 16, further comprising:
output, by the trained metadata extractor, explainability metadata of the at least one application;
generate a validation interface component comprising the explainability metadata;
transmit the validation interface component to a user device; and
trigger a configuration of a graphical user interface of the user device based on transmitting the validation interface component.
